(19) United States
(12) Patent Application Publication
(10) Pub. No.: US 2009/0165875 A1
(43) Pub. Date: Jul. 2, 2009

(54) ASSEMBLY FOR SAVING WATER

(75) Inventor: Eric Winn, New South Wales (AU)

Correspondence Address: BENESCH, FRIEDLANDER, COPLAN & ARONOFF LLP;ATTN: IP DEPARTMENT DOCKET CLERK, 200 PUBLIC SQUARE, SUITE 2300, CLEVELAND, OH, 44114-2378, US

(73) Assignee: WINNS FOLLY PTY LTD., East Gosford (AU)

(21) Appl. No.: 11/720,743

(22) PCT Filed: Dec. 5, 2005
(86) PCT No.: PCT/AU05/01837

§ 371 Date: Aug. 22, 2007

(30) Foreign Application Priority Data
Dec. 3, 2004 (AU) 2004906954

(51) Int. Cl. F16K 31/00

(52) U.S. Cl. 137/624.27

(57) ABSTRACT

A water saving assembly for use in a water supply system, the assembly including: a storage chamber (12) adapted to be in fluid communication with a water conduit (14); a temperature sensor (26) for determining the temperature of water in the conduit; flow directing means (24); and a control device (32) for receiving input of the determined temperature from the temperature sensor and for controlling the flow directing means (24); wherein, under the control for the control device, the flow directing means is adapted to selectively either; (a) direct water in the conduit into the storage chamber when the sensor (26) has determined the water temperature to be below a predetermined temperature; or (b) inhibit water in the conduit from entering the storage chamber when the sensor (26) determined the temperature to be at or above the predetermined temperature.

### FIELD OF THE INVENTION

The present invention relates to an assembly for saving water. In particular, the present invention relates to an assembly that allows cooled hot water in a hot water pipe to be retained and used rather than simply allowing it to run down the drain.

### BACKGROUND OF THE INVENTION

Water is a finite and valuable commodity. As the population of the world continues to grow and the demand for water constantly increases, the value of water will continue to rise.

The value of water is particularly high in regions where water is scarce, where demand is high or which are subject to drought. There is a growing awareness that water is a valuable commodity that should not be wasted.

Permanent water restrictions are becoming an everyday reality in some areas and citizens are being encouraged to conserve water in any way they can. The majority of water required by a household is used for “non-drinking” purposes such as showering, flushing toilets, in the laundry of in automatic or manual dishwashers. For several of these uses, a substantial amount of the water is hot water.

Hot water is delivered to outlets, such as taps and showers, through a piping system from one or more hot water heaters, it is a common experience when turning on a hot water tap that a volume of cold water is first delivered through the pipe, until the water “heats up”. This is due to a volume of water (sometimes known as a “slug”) that remains in the pipe between the tap and hot water system after the tap is turned off. When there is a substantial time lapse between the next use of the tap (such as overnight), the slug will cool in the pipe and is delivered out of the tap as cold water. In most cases this cold water slug is simply allowed to run down the drain and is therefore wasted.

Although a single slug is generally not a particularly large volume of water, when it is multiplied by the number of hot water outlets in the average household, then by the number of households, and then by the number of times a hot water tap is turned on (after the ‘slug’ has cooled), it will be realised that a very large volume of water is being wasted. This wasted water also increases the costs of water incurred by a household.

This aspect of water wastage has been approached in a number of ways in the past. In some known prior art systems the water is recycled back to the hot water system or into the cold water line thereby introducing cross-contamination. Some systems remove all the slug from the entire hot water line. Although such systems save the slug, the entire line must be reheated every time it is used. Typically this needs to be manually performed, for example, by the user pressing a button.

One proposed solution is to continuously recirculate the hot water throughout the piping system until it is actually required, thereby preventing cooling of the hot water in the pipes. Whilst this may be feasible where hot water is continually required, such as in a large hotel or a hospital, it is not feasible in a domestic household where there are long periods of time during which hot water is not required. Moreover, the costs of the energy requirements for continuously recirculating hot water in either of these environments may in some cases outweigh the benefit of any water saving.

An alternative solution is provided in U.S. Pat. No. 5,794,643, which describes a vacuum flow assembly that is inserted into a hot water supply line and also connected to a diversion line that terminates in a containment device. In use, the cold water slug in the hot water supply line is diverted into the containment device when the hot water tap is turned on. After the containment device is fitted, a valve is switched, that results in the water flow proceeding along the hot water supply line, and the diverted water being moved from the containment device bade into the hot water supply line to be delivered with the hot water.

Whilst representing a better solution for a domestic household compared to continuous recirculation systems, the assembly requires the containment device to be full before the slug is introduced back into the hot water supply line. This could result in an unacceptable time delay in hot water delivery, thereby red u ring the chance that such devices would be readily adopted.

Another problem with many of the prior art systems is that they may not be adaptable to accommodate the use of a Flickmixer™ type tap that enables both hot and cold water to be mixed, prior to leaving the outlet.

Furthermore, the prior art systems generally do not make the wasted water or slug from, for example, a shower, to be available for use in flushing a toilet. With systems that use rain water tanks there are at least five major problems:
1. If there is no rain for some time, the water will run out and will need to be topped-up from the main supply.
2. The water in the tank is typically, contaminated by dirt and leaves from the roof.
3. There is a significant amount of noise associated with using the toilet which can be a problem for households, especially at night time.
4. The cost of running and maintaining the pumps associated with such systems is high.
5. If there is a power failure, the system will not work.

Accordingly, this invention is directed to providing an improved or alternative assembly for reducing wastage of water in a hot water tap system.

### SUMMARY OF INVENTION

According to the invention, there is provided a water saving assembly, for use in a water supply system, the assembly including:
a storage chamber adapted to be in fluid communication with a water conduit;
a temperature sensor for determining the temperature of water in the conduit;
flow directing means; and
a control device for receiving input of the determined temperature from the temperature sensor and for controlling the flow directing means;
wherein, under the control for the control device, the flow directing means is adapted to selectively either.
   (a) direct water in the conduit into the storage chamber, when the temperature sensor has determined the water temperature to be below a predetermined temperature; or
   (b) inhibit water in the conduit from entering the storage chamber when the temperature sensor has determined the water temperature to be at or above the predetermined temperature.

Generally, the operating of the flow directing means is responsive to the temperature of the water as recorded by the temperature sensor. The flow directing means is thereby adapted to direct water into the storage chamber when the temperature of the water is less than b predetermined value and to inhibit water flowing into the chamber when the temperature is at or above this value, in this way, cool water in the water conduit is not discarded and let to flow down the drain.

In one preferred embodiment, the invention further includes blending means adapted to cause water in the storage chamber to move from the storage chamber to the conduit and to be blended with flowing (eg hot) water in the conduit when the flow directing means is inhibiting flow of water into the storage chamber. In this embodiment, the present invention typically therefore uses the cold water slug that would otherwise be wasted, by blending it with hot water in the conduit thereby reducing the overall volume of water that is used.

In contrast to certain prior art systems, the present invention does not require a valve to be manually switched or the storage chamber to be filled before hot water is delivered through the conduit.

Alternatively, the water which flows into the storage chamber could be returned to the hot water reservoir or redirected to some other section of the water piping system (eg the cold water pipes). In an alternative embodiment the storage chamber could be the hot water reservoir in which case the redirected cool slug of water is returned directly to this reservoir after being redirected from the water conduit.

The flow directing means may take any convenient form. In one embodiment, the flow directing means includes a valve assembly adapted so that, in a redirection condition, the valve assembly defines a water-flow path from the conduit to the storage chamber whilst blocking water flow through the conduit and, in a flow condition, the valve assembly blocks water flow to the storage chamber whilst allowing water flow through the conduit. Transformation of the valve assembly between the redirection condition and the flow condition is responsive to the water temperature as determined by the temperature sensor, the transformation being controlled by the control device.

Preferably, the valve assembly includes a first valve member adapted to control the flow of water to the storage chamber and a second valve member adapted to control the flow of water in the conduit. The first and second valve members are preferably selectively rotatable between an open position and a dosed position. Typically, these valve members are adapted so that, when the first valve member is open, the second valve member is closed, and vice versa.

The redirect/on condition of such embodiments is preferably defined when first valve member is in the open position and the second valve member is in the closed position. The flow condition is preferably defined when the first valve member is in the closed position and the second valve member is in the open position.

The temperature sensor, the control device and the flow directing means may be arranged in any convenient manner that enables the flow directing means to respond to changes in temperature of the water in the conduit (as determined by the temperature sensor). When the temperature is at or above the predetermined temperature the flow directing means, is in (or transforms to) the flow condition, and when the temperature is below the predetermined temperature, the flow directing means is in (or transforms to) the redirection condition.

In one preferred embodiment, the temperature sensor, the control device and flow directing means are electronically coupled, wherein the temperature sensor sends an electronic signal the control device which in turn controls the flow directing means so that it is in the correct condition, depending on the temperature of the water. Other modes of connection between the temperature sensor, the control device and the flaw. directing means are contemplated within the scope of the present invention, such as mechanical coupling.

The control device (eg a microprocessor) is interposed between the temperature sensor and the flow directing means for more refined operation of the flow directing means. Once hot water has flowed through the conduit to the tap, shower head or other outlet, the water in the conduit wilt remain hot for a period. Accordingly, in preferred embodiments, the control device incorporates at least about a 5 minute delay which obviates the necessity for the water saving assembly to perform its usual cycle (of redirecting water) during that period of time.

Preferably, the water saving assembly further includes a flow sensor coupled to the flow directing means, wherein the flow sensor operates with the flow directing means to commence directing water flowing along the conduit into the storage chamber when water flow along the conduit is first detected by the flow sensor.

The blending means may take any convenient form. Preferably, the blending means includes a venturi located in the conduit, the flow of water through the venturi causing a vacuum that draws water from the storage chamber into the conduit to be blended with the flowing water. Other forms of blending means are contemplated within the scope of the present invention.

The blending means is preferably configured to draw water from the storage chamber at a such a rate that all water in the storage chamber is blended with flowing water in the conduit. This will generally depend on the expected volume and flow rate of water to be used. For example, in the case of a shower, the blending means may be configured to draw water from the storage chamber at a rate of between about 1 and 2 litres per minute, preferably, around 1.5 litres per minute. As the normal flow rate of a shower is between 9 and 20 litres per minute, this would take approximately 3 minutes to empty the storage chamber, being roughly the time of an average shower. The effectiveness of this blending means to draw water from the storage tank, will partly depend on the rate at which water flows through the conduit.

In another preferred embodiment, the directing of the water into the storage chamber is facilitated by use of mains pressure. The storage chamber may be in the ceiling. In such embodiment, the water that is directed into the storage chamber becomes available for use in the toilets by gravity feed, and no power is required to supply this Water to the toilets.

In further preferred embodiments, the storage chamber may be fitted with an overflow to a larger tank for further directing some or all of the water for other uses, such as in the garden.

The storage chamber of such embodiments may also preferably be fitted with an emergency back-up from the mains pressure to ensure that there is always sufficient water in the storage chamber to service flushing of a toilet or more than one toilet.

In yet still further preferred embodiments, water that is directed into the storage chamber may further be directed into a holding tank. This further redirection may be facilitated by mains pressure. In such embodiments, water in the holding tank becomes available for use in the toilets or for other uses as set out above. The holding tank may also be fitted with an overflow to a larger tank, and may also be fitted with an emergency back-up from mains pressure as set out above.

In yet still further preferred embodiments, the water saving assembly of the present invention can be used in conjunction with a Flickmixer™tap. As would be appreciated by persons skilled in the art, such a tap typically allows both hot and cold water to be drawn toward the outlet simultaneously. Accordingly, in such preferred embodiments, the assembly further includes a one-way valve in the cold water line which operates simultaneously with transformation of the flow directing means into the redirection condition, such that the one-way valve inhibits cold water from flowing out of the outlet until the temperature sensor determines that the temperature in the conduit is at or above the predetermined temperature.

Accordingly, preferred embodiments of the water saving assembly of the present invention are capable of preserving water and saying costs.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of each claim of this specification.

In order that the present invention may be more clearly understood, preferred embodiments will be described with reference to the following drawings and examples.

### BRIEF DESCRIPTION OF THE DRAWINGS

Embodiments of the present invention will now be described with reference to the accompanying drawings wherein:

FIG. 1 is a schematic view of an assembly for saving water in the redirection condition and before the hot water tap is turned on;

FIG. 2 is a schematic view of an assembly for saving water in the redirection condition and after the hot water tap is turned on;

FIG. 3 is a schematic view of the assembly in the flow condition;

FIG. 4 is a schematic view of a second embodiment of an assembly for saving water;

FIG. 5 is a schematic view of a preferred embodiment of an assembly for saving water according to the invention, wherein the outlet is a shower head;

FIG. 6 is a schematic view of yet another preferred embodiment of an assembly for saving water, wherein the outlet is a sink Spout; and

FIG. 7 is a schematic view of yet another preferred embodiment of an assembly for saving water, the assembly being adapted to be used in conjuction with a flickmixer.

### DETAILED DESCRIPTION OF THE DRAWINGS

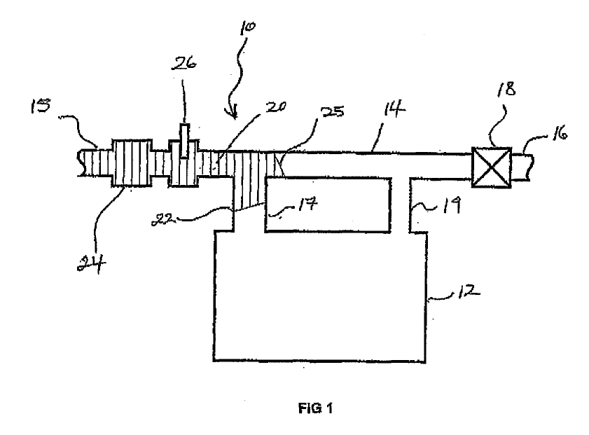

Turning to FIG. 1, an assembly 10 for saving water is illustrated. The assembly includes a storage member, in the form of a chamber 12, that is connected to a conduit 14, with passageways 17 & 19 extending between the conduit and storage chamber, in this embodiment, the conduit 14 is integrally formed with the assembly 10, which may be retro-fitted into the hot water pipe 15 & 16. This is not essential however, and the conduit 14 could form part of the hot water pipe, in which case the storage chamber 12 and the passageways 17 and 19 could be separately connected to the conduit 14.

In the usual state of affairs, after a tap 18 is turned on, hot water flows from a hot water heater (not shown) through the pipe 15 and conduit 14 and then flows through a pipe 18 out to its destination such as a sink, shower, washing machine, dishwasher or other outlet. As described above, a slug of water 20 (indicated with vertical lines) remains in the pipe after the tap 18 is switched off and cools during a period when the hot water is not used. When the tap 18 is next turned on, the slug 20 is simply allowed to run down out through the pipe 16 and is generally wasted.

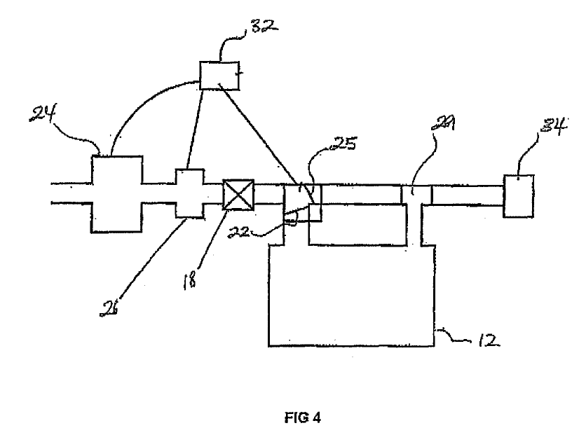

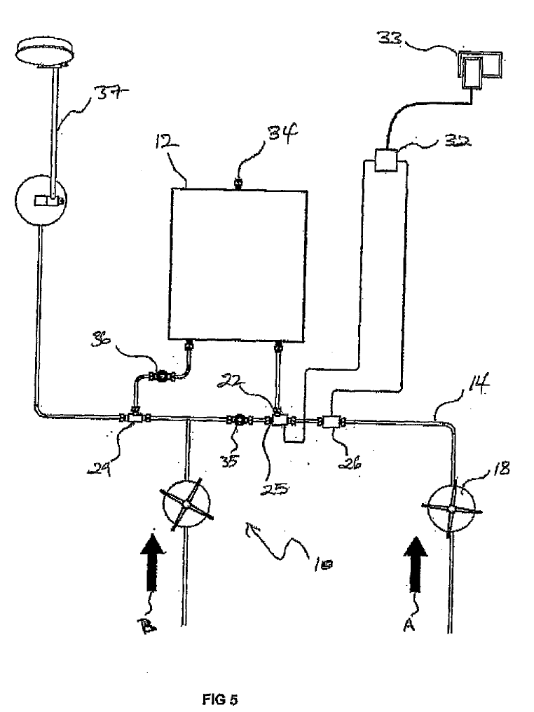

However, using the assembly 10 of the present invention, a flow switch 24 disposed in the conduit 14, detects the occurrence of water flow when the tap 18 is turned on. This causes an electronic signal to be sent to a controller (32 in FIG. 4) that in turn signals a valve actuator (not shown) to open a first valve member 22.

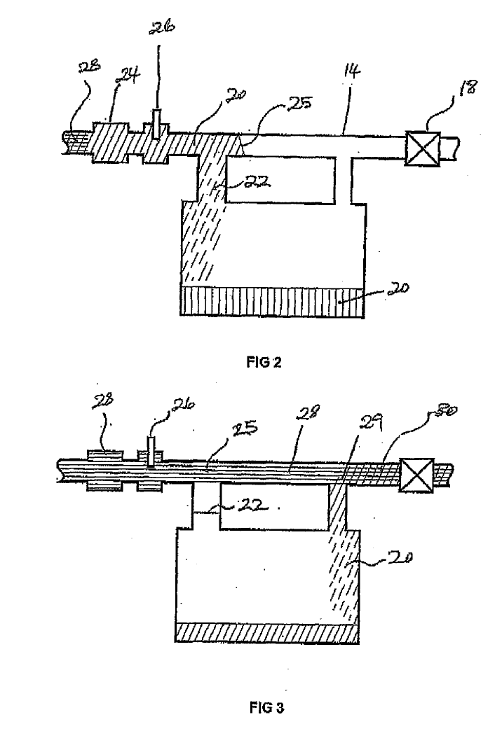

As illustrated in FIG. 2, the first valve member 22 is located adjacent an entrance to the storage chamber 12, so that when the first valve member is opened, the slug 20 is redirected into the storage chamber 12. A second valve member 25, that is located transverse to the longitudinal axis of the conduit, is initially closed and therefore inhibits the flow of water through the conduit 14. This also assists in redirection of the slug 20 into the storage chamber 12.

At the same time, hot water 28 (indicated by horizontal lines) starts to flow through the hot water pipe 15 and into the conduit 14. The temperature of water in the conduit will begin to rise as the hot water 28 begins to displace the cold water 20, which is being redirected into the storage chamber. The water temperature can be measured by a thermostat 26 that is located in the conduit 14, upstream from the passageway 17 into the storage chamber 12.

Turning next to FIG. 3, the hot water 28 continues to flow into the conduit 14 and progressively displaces the cold water 20, thereby causing the temperature of water in the conduit to rise. Once the temperature reaches a predetermined value (which can be set via the controller), the thermostat sends an electrical signal to the controller, that in turn opens the second valve member 25 and closes the first valve member 22. This has the effect of blocking the flow of water into the storage chamber 12 and allowing water to flow through the conduit 14. Because the operation of the valve assembly 22 & 25 is dependent on the water temperature, the first water allowed through the conduit will be hot water, that will then flow through the pipe 16 to its intended destination.

A venturi 29 is provided in the conduit downstream from the thermostat 26, and when the hot water 29 flows past the venturi, an area 30 of lower pressure is created. This has the effect of creating a vacuum, or at least a region of reduced pressure, in an adjoining section of the conduit 14, which draws cold water 20 in the storage chamber 12, up through the second passageway 19 and into the conduit 14 to be blended with the hot water 28 flowing along the conduit. The blended water can then flow out through the pipe 16 to the intended destination.

The rate at which cold water 20 is drawn up from the storage chamber 12 depends on a number of on factors such as the relative diameters of the venturi and conduit, the flow rate of the hot water, and the size of the storage chamber. These can be varied to provide a suitable blending rate for particular situations and to ensure that all of the cold water 20 in the storage chamber 12 is used. For some applications, such as showers, the water should not be blended at too high a rate so that the temperature of the received water is not lowered by an amount that would be noticeable. However, in other applications, such as dishwashers or washing machines this is not as important a consideration.

Turning to FIG. 4, a second embodiment of an assembly 10 for saving water is illustrated where the tap 16 is located upstream of the valve assembly 22 & 25, and adjacent to the thermostat 26. This embodiment functions in an essentially equivalent manner to the embodiment described by reference to FIGS. 1 to 3, with the water slug in the pipe being first directed to the storage member when the tap 18 is turned on. Once the water reaches a predetermined temperature, as measured by the thermostat 26. the thermostat 26 sends an electronic signal to the controller 32 that then operates the valve assembly 22 & 25 to allow water to flow through the conduit 14 and out to the shower rose 34 or other outlet Flow of water through the conduit 14 again causes the venturi 29 to draw the diverted water up from the storage chamber 12 and into the conduit 14 to be blended with the flowing water in the conduit.

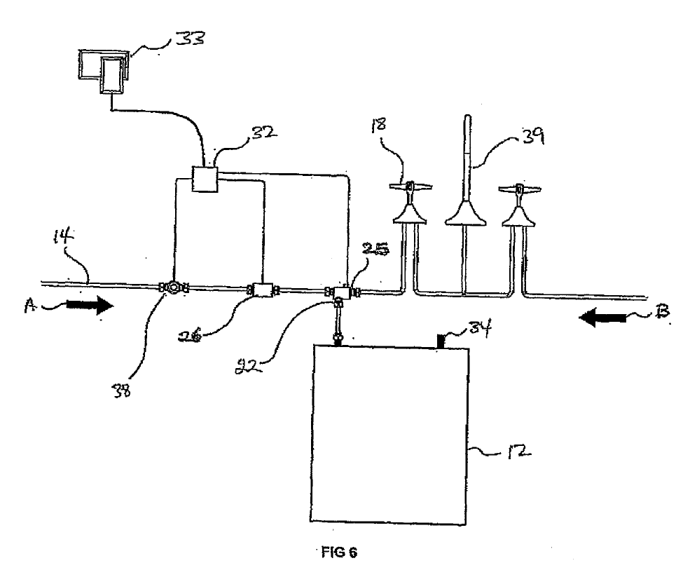

Turning to FIG. 5, arrow A shows the direction of the flow of hot water and arrow B shows the direction of flow of cold water. When tap 18 is turned on, hot water flows in conduit 14. Thermostat 26 determines the temperature of the water in the conduit and inputs its determination of the water temperature to controller 32, Controller 32 is powered by power supply 33. If the water in conduit 14 is below a predetermined temperature, controller 32 provides input to the flow directing means such that valve 22 opens and valve 25 doses, thereby diverting the cold water into storage chamber 12. In some preferred embodiments, mains pressure is used to facilitate the movement of the water into storage chamber 12.

As illustrated in FIG. 5, in some embodiments, the storage chamber 12 can be a holding tank preferably located in the ceiling. Accordingly, water diverted into the holding tank becomes available for use (n toilets by gravity feed.

Once the water in conduit 14 is at or above a predetermined temperature, thermostat 26 provides input to the control device which in turn instructs the flow directing means to change valve 22 to the closed condition and valve 25 to the open condition thereby allowing the hot water to continue along conduit 14 to shower head 37 or other outlets. Meanwhile, venturi 29 operates to draw cold water from storage chamber 12 back into conduit 14 so that it can be blended with the hot water. As illustrated in FIG. 5, optionally non-return valves 35 and 36 are installed so as to prevent back-flow of water. An air vent 34 is optionally installed in storage chamber 12.

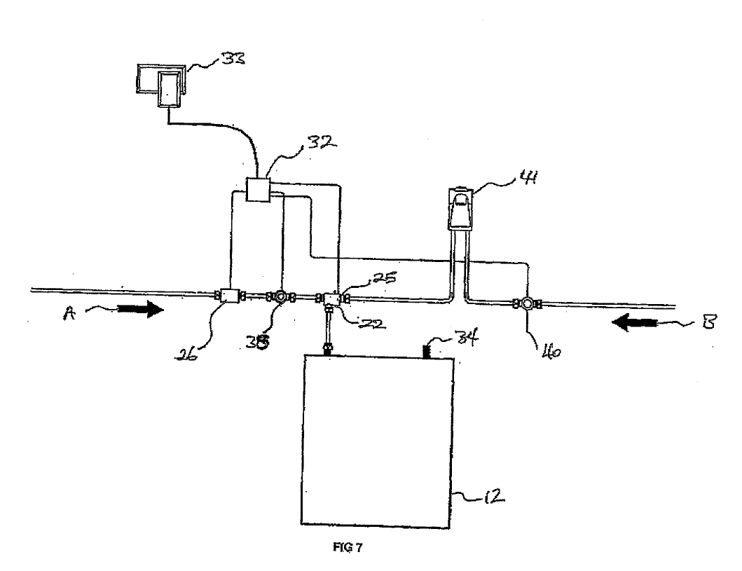

FIG. 6 illustrates a further, preferred embodiment of the water saving assembly of the present invention. Much of the description in relation to FIG. 5 relates to the embodiment in FIG. 8. As can be seen, however, FIG. 6 includes a flow switch 38 upstream of thermostat 26 in conduit 14. In this preferred embodiment, the flow switch 38 is also connected to controller 32 and provides input to controller 32 when it detects the flow of water through conduit 14. This provides a yet more refined approach to operating toe assembly of the present invention, wherein the controller 32 receives information, from the flow switch 38 and the thermostat 26.

FIG. 7 illustrates yet another preferred form of the invention adapted to be used in conjunction with a flickmixer 41, As can be seen, in this embodiment, flow switch 38 is located downstream from thermostat 28. A one-way valve 40 is installed in the cold water conduit along which the cold water flow path is identified as arrow B.

One-way valve 40 is also controlled by controller 32. In this embodiment, when thermostat 26 detects that the water in conduit 14 is below the predetermined temperature, it inputs that information into controller 32 which in turn instructs valve 25 to close, valve 22 to open, and one-way valve 40 to close. This will continue to be the state of affairs until such time as toe water in conduit 14 reaches or goes above the predetermined temperature, at which time thermostat 26 will input this information to controller 32, which in turn will open valve 25, close valve 22 and open on B-way valve 40. In this embodiment, cold water is, therefore, prevented from reaching flickmixer 41, until such time as hot water is detected as being present in conduit 14 and is, therefore, available for mixing with cold water from the cold water conduit at flickmixer 41.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1-31. (canceled)

32. A water saving assembly for use in a water supply system comprising:
a flow sensor for determining whether water is flowing in a hot water conduit;
a temperature sensor for determining the temperature of water in the hot water conduit;
flow directing means; and
a control device for receiving input from the flow sensor and from the temperature sensor and for controlling the flow directing means;
wherein, under the control of the control device, the flow directing means is adapted to selectively:
a. direct water in the hot water conduit to a storage chamber when the flow sensor has determined that there is water flowing in the conduit; or
b. inhibit water in the hot water conduit from entering the storage chamber when the temperature sensor has determined the temperature of water in the hot water conduit to be at or above a predetermined temperature.

33. The water saving assembly of claim 32, wherein the flow directing means includes a valve assembly capable of transforming between a water redirection condition and a water flow condition.

34. The water saving assembly of claim 33, wherein, when in the redirection condition, water flows from the conduit to the storage chamber.

35. The water saving assembly of claim 33, wherein, when in the flow condition water flows through the conduit, whilst being inhibited from flowing into the storage chamber.

36. The water saving assembly of claim 33, wherein a transformation between the flow condition and the redirection condition is responsive to the flow of water in the water conduit as determined by the flow sensor.

37. The water saving assembly of claim 33, wherein a transformation between the redirection condition and the flow condition is responsive to the water temperature as determined by the temperature sensor.

38. The water saving assembly of claim 33, wherein, when the temperature of the water in the conduit is at or above the predetermined temperature, the assembly is adapted so that the flow directing means is in the flow condition.

39. The water saving assembly of claim 33, wherein the valve assembly includes a first valve member adapted to control the flow of water to the storage chamber and a second valve member adapted to control the flow of water in the conduit.

40. The water saving assembly of claim 39, wherein the first and second valve members are selectively moveable between an open position and a closed position.

41. The water saving assembly of claim 40, wherein the valve assembly is in the redirection condition when the first valve member is in the open position and the second valve member is in the closed position.

42. The water saving assembly of claims 40, wherein the valve assembly is in the flow condition when the first valve member is in the closed position and the second valve member is in the open position.

43. The water saving assembly of claim 32, wherein the flow sensor, temperature sensor, control device and flow directing means are electronically coupled such that the flow sensor and the temperature sensor send an electronic signal to the control device which in turn controls the flow directing means to transform between a redirection condition and a flow condition.

44. The water saving assembly of claim 32 further including a one-way valve in a cold water conduit.

45. The water saving assembly of claim 44 wherein when the flow sensor sends a signal to the control device that there is flow of water in the hot water conduit, the control device controls the one-way valve to inhibit water from flowing along the cold water conduit.

46. The water saving assembly of claim 44 wherein when the temperature sensor sends a signal to the control device that the temperature of the water in the hot water conduit is at or above the predetermined temperature, the control device controls the one-way valve to allow water to flow along the cold water conduit.

47. The water saving assembly of claim 32, wherein the control device provides for a temporal period during which the valve assembly is inhibited from undergoing any transformation.

48. The water saving assembly of claim 32, wherein water directed into the storage chamber is available for use in one or more toilets or other water outlet.

49. The water saving assembly of claim 44 adapted to be used in conjunction with a water mixing tap.

50. The water saving assembly of claim 32 wherein the flow sensor is a flow switch.

51. A water saving assembly for use in a water supply system comprising:
a flow sensor for determining whether water is flowing in a hot water conduit;
a temperature sensor for determining the temperature of water in the hot water conduit;
flow directing means;
a one-way valve in a cold water conduit; and
a control device for receiving input from the flow sensor and from the temperature sensor and for controlling the flow directing means and the one-way valve;
wherein, under the control of the control device,
a. the flow directing means is adapted to selectively:
(i) direct water in the hot water conduit to storage when the flow sensor has determined that there is water flowing in the conduit; or
(ii) inhibit water in the hot water conduit from entering storage when the temperature sensor has determined the temperature of water in the conduit to be at or above a predetermined temperature; and
b. the one-way valve is adapted to selectively:
(i) inhibit water from flowing along the cold water conduit when the flow sensor has determined that there is water flowing in the hot water conduit; or
(ii) allow water to flow along the cold water conduit when the temperature sensor has determined the temperature of water in the hot water conduit to be at or above a predetermined temperature.

52. The water saving assembly of claim 51 adapted to be used in conjunction with a water mixing tap.

53. The water saving assembly of claim 51 wherein the flow sensor is a flow switch.
